(19) United States
(12) Patent Application Publication
(10) Pub. No.: US 2011/0115891 A1
(43) Pub. Date: May 19, 2011

(54) ENERGY DELIVERY APPARATUS, SYSTEM, AND METHOD FOR DEPLOYABLE MEDICAL ELECTRONIC DEVICES

(75) Inventor: Robert M. Trusty, Cincinnati, OH (US)

(73) Assignee: Ethicon Endo-Surgery, Inc., Cincinnati, OH (US)

(21) Appl. No.: 12/617,998

(22) Filed: Nov. 13, 2009

(51) Int. Cl. H04N 7/18; H01F 38/00; H02J 7/00; F21L 4/00; H04Q 5/22

(52) U.S. Cl. 348/65; 307/104; 320/137; 320/166; 320/127; 362/157; 340/10.1; 348/E07.085

(57) ABSTRACT

An energy consuming module includes an electronic component suitable for use within a body cavity is disclosed. An antenna is coupled to the electronic component to communicate signals. A wireless energy module is coupled to the electronic component. A positioning element is used to locate the electronic component within the body cavity. A housing is used to support the electronic component, the antenna, the wireless energy module, and the positioning element. A system further includes a manipulation module for use external to the body cavity to manipulate the positioning element of the energy consuming module. The manipulation module includes a wireless energy transmitter element to supply energy to the wireless energy module of the energy consuming module, a communication circuit coupled to an antenna to communicate signals between the electronic component and the manipulation module, and a positioning element to locate and position the energy consuming module within the body cavity. The energy consuming module may include at least one electric terminal coupled to the energy module to receive an electric conductor to supply energy to the energy module from an energy source located outside the body cavity.

### BACKGROUND

Minimally invasive surgical procedures may employ endoscopic, laparoscopic, thoracoscopic, open surgical procedures, or any combinations thereof. Such minimally invasive procedures typically employ the use of a scope such as an endoscope, laparoscope, or thoracoscope, which comprises a rigid or flexible tube with a lens based system that is usually connected to a video camera (single chip or multi chip) or a distal electronic integrated circuit (chip) based system that places the video camera optics and electronics at the tip of the scope. Also attached to the proximal end of the scope may be a fiber optic cable system connected to a light source (halogen or xenon) to illuminate the operative field. Alternatively, illumination may be achieved using a solid-state element, such as a light emitting diode (LED) placed at the distal end of the scope. Laparoscopes may be inserted through 5 mm or 10 mm trocars or keyholes to view the operative field. In laparoscopic procedures, the abdomen is usually insufflated with carbon dioxide gas elevating the abdominal wall above the internal organs like a dome to create a working and viewing space. Carbon dioxide gas is used because it is common to the human body and can be removed by the respiratory system if it is absorbed through tissue. Flexible endoscopes are usually flexible and may be inserted in natural openings of a patient such as the mouth, anus, and/or vagina and used intralumenally, but in Natural Orifice Trans-lumenal Endoscopic Surgery (NOTES™) procedures, the scope may transit the lumen wall and enter the abdominal or thoracic cavity. Thoracoscopes are generally inserted through the chest to access the lungs.

Electronic devices are routinely deployed inside a patient's body. Devices such as pacemakers may be permanently deployed whereas devices such as illumination sources or visualization devices may be temporarily deployed inside a patient's body during minimally invasive surgical procedures. Such electronic devices require a source of electrical energy in order to operate. Conventionally, energy is supplied to such energy consuming electronic devices by way of wires and/or optical fibers embedded in the instrument shaft. Recently, a new class of temporarily deployable visualization and therapy devices have been contemplated and published. These devices may be suspended inside of the abdominal or thoracic cavity from magnets or other mechanical elements, such as discussed in commonly owned U.S. patent application Ser. No. 12/170,862, Titled “TEMPORARILY POSITIONABLE MEDICAL DEVICES,” filed on Jul. 10, 2008, which is incorporated herein by reference in its entirety. Typically, energy is supplied to these devices by way of over electronic tethers, which can tend to somewhat restrict movement and flexibility. These tethers can take up valuable space in trocars or cause leaks if run alongside a trocar. One way to overcome these issues is to make additional incisions in the patient's body in order to provide the energy supplying wires to the energy consuming device away from the trocar. Another alternative, batteries, provide a limited amount of energy and may run out of energy during a procedure. Furthermore, batteries are bulky and costly to replace.

In the context of minimally invasive surgical or diagnostic procedures, energy consuming electronic medical devices are routinely deployed inside a patient for viewing portions of the patient's anatomy. To view a desired site of the anatomy (e.g., treatment region worksite, treatment site, target site), a clinician (e.g., a surgeon) may insert a rigid or flexible scope inside the patient. Surgical devices also may be inserted through one or more channels of the scope, through a trocar, or other conduit or lumen to perform various surgical activities, manipulate tissue, or take a sample from a site to test for diseased tissue, e.g., remove a biopsy sample. Visualization systems including cameras, illumination sources, and communication electronics are used to navigate through body cavities or lumens, locate the distal end of the scope at the site, render images of the site, and transmit the images to a display device where they are used by the clinician during the surgical procedure to locate and operate the surgical devices introduced through channels within the scope or the trocar. As previously discussed, however, wiring necessary to supply electrical energy to the visualization system (e.g., camera, light source, transmitter electronics) takes up valuable space within the scope channels that could be used for more sophisticated and/or larger therapeutic or surgical medical devices.

In multi-port and single-port laparoscopic, and natural orifice endoscopic translumenal procedures developed by Ethicon Endo-Surgery, Inc., known in the art as NOTES™ procedures, a significant amount of real estate can be used by the visualization system. In multi-port procedures, one 5 mm or 10 mm port is typically dedicated to providing percutaneous illumination and imaging. In single-port procedures, the same laparoscope may be used in one of the keyholes within the trocar, or an independent flexible scope may be inserted via a natural orifice to provide visualization without using one of the limited numbers of keyholes available in a multi-port trocar. In NOTES™ and NOTES™ hybrid procedures, a flexible endoscope is typically used to access, visualize, and provide channels to deliver therapy to the site. A significant portion of the scope is dedicated to supporting the illumination (optical fibers or LEDs) and imaging devices such as (charge coupled devices (CCD) or complementary metal oxide semiconductor (CMOS) integrated circuit based cameras, lenses, lens-cleaning). This limits the number and size of channels available for therapy or is cause for a scope diameter to be larger than desired.

Additionally, in NOTES™ and multi-port procedures, it is also anticipated that surgeons will want to maintain the same reference viewpoint provided in open or laparoscopic surgeries without accepting any loss of quality in the visualization system. In a laparoscopic procedure, the clinician controls the orientation of the visualization system by panning, zooming, and by rotating the scope about its optical axis, rotating the scope about the trocar/tissue pivot point, and moving the laparoscope in and out. All of these capabilities will continue to be desirable to a surgeon and may need to be accomplished independently of tissue manipulation operations. Thus, in addition to providing a remote source of energy to energy consuming visualization devices, the disclosed embodiments also provide a visualization system that is remotely positionable and manipulatable.

### SUMMARY

In one embodiment, an apparatus comprises an electronic component suitable for use within a body cavity. An antenna is coupled to the electronic component to communicate signals. A wireless energy module is coupled to the electronic component. A positioning element is used to locate the electronic component within the body cavity. A housing supports the electronic component, the antenna, the wireless energy module, and the positioning element.

### FIGURES

FIG. 1 illustrates one embodiment of a system comprising one embodiment of an energy consuming module deployed within a body cavity of a patient and one embodiment of a manipulation module located external to the body cavity.

FIG. 2 is a detail perspective view of the system illustrated in FIG. 1.

FIG. 3 is a schematic diagram of one embodiment of the system shown in FIGS. 1 and 2.

FIG. 4 is a schematic diagram of one embodiment of an imaging device portion of the embodiment of the energy consuming module shown in FIGS. 1-3.

FIG. 5 is a partial cut-away perspective view of one embodiment of an energy consuming module.

FIG. 6 is a cross-sectional view of the embodiment of the energy consuming module shown in FIG. 5.

FIG. 7 is a side view of the embodiment of the energy consuming module shown in FIG. 5.

FIG. 8 is an end view of the embodiment of the energy consuming module shown in FIG. 7 taken along line 8-8.

FIG. 9 is an exploded view of the embodiment of the energy consuming module shown in FIGS. 5-8.

FIG. 10 is a perspective view of one embodiment of a housing portion of the embodiment of the energy consuming module shown in FIGS. 5-8.

FIG. 11 is an alternate perspective view of the embodiment of the housing shown in FIG. 10.

FIG. 12 is a side view of the embodiment of the housing shown in FIG. 10.

FIG. 13 is an end view of the embodiment of the housing shown in FIG. 12 taken along line 13-13.

FIG. 14 is an end view of the embodiment of the housing shown in FIG. 12 taken along line 14-14.

FIG. 15 is a side view of one embodiment of a wireless energy module comprising a camera body containing various elements of an electronic component including an imaging device, an imaging camera, a transmitter, and an antenna.

FIG. 16 is a perspective view of the embodiment of the wireless energy module shown in FIG. 15.

FIG. 17 is a perspective view of a positioning element portion of the embodiment of the energy consuming module shown in FIGS. 5-8.

FIG. 18 is a perspective view of one embodiment of an illumination source of the embodiment of the energy consuming module shown in FIGS. 5-8.

FIG. 19 is perspective view of one embodiment of an optical system of the embodiment of the energy consuming module shown in FIGS. 5-8.

FIG. 20 is a perspective view of one embodiment of a manipulation module of the embodiment of the system shown in FIGS. 1 and 2.

FIG. 21 is a perspective view of a visualization module with a tether as deployed within a body cavity.

FIG. 22 is a perspective view of one embodiment of an in-flight charging grasper preparing to grasp a visualization module deployed within a body cavity.

FIG. 23 is a perspective view of a detailed view of grasper jaws and one embodiment of a feature of one embodiment of the visualization module shown in FIG. 22.

FIG. 24 is an alternate perspective view of a detailed view of grasper jaws and one embodiment of a feature of one embodiment of the visualization module shown in FIG. 22.

FIG. 25 is a perspective view of one embodiment of the jaws portion of the embodiment of the grasper shown in FIGS. 22-24.

The novel features of the various embodiments are set forth with particularity in the appended claims. The various embodiments, however, both as to organization and methods of operation may be best understood by reference to the following description, taken in conjunction with the accompanying drawings as follows.

### DESCRIPTION

Various embodiments are disclosed for supplying energy to energy consuming medical electronic devices. More particularly, various embodiments are disclosed for supplying energy to visualization and illumination devices deployable inside a patient's body.

Before explaining the various embodiments in detail, it should be noted that the embodiments are not limited in their application or use to the details of construction and arrangement of parts illustrated in the accompanying drawings and description. The illustrative embodiments may be positioned or incorporated in other embodiments, variations and modifications, and may be practiced or carried out in various ways. For example, the energy transfer delivery devices and energy consuming modules disclosed herein are illustrative only and not meant to limit the scope or application thereof. Furthermore, unless otherwise indicated, the terms and expressions employed herein have been chosen for the purpose of describing the illustrative embodiments for the convenience of the reader and not to limit the scope thereof.

In the following description, like reference characters designate like or corresponding parts throughout the several views. Also, in the following description, it is to be understood that terms such as “inside” and “outside,” and the like are words of convenience and are not to be construed as limiting terms. Terminology used herein is not meant to be limiting insofar as devices described herein, or portions thereof, may be attached or utilized in various orientations. The various embodiments will be described in more detail with reference to the drawings.

The described embodiments of devices and methods for remotely supplying energy to (e.g., remotely-powering) energy consuming electronic medical devices can eliminate the need for dedicated laparoscope trocars or use of dedicated keyholes in single and multi-port laparoscopic procedures, and can eliminate the need for a secondary access point (natural orifice or others) into the patient's body for visualization and/or therapeutic purposes. The described embodiments of devices and methods for remotely-powering energy consuming electronic medical devices can also eliminate the need for a tether that connects the electronic devices to a power source located outside the patient's body. Additionally, certain embodiments described herein provide devices and methods for remotely-powering energy consuming electronic medical devices to reduce or eliminate the need for batteries, and thus greatly reducing the required volume and eliminating battery-based limitations on operating time. Such devices also can allow for larger channels and more flexible NOTES™ platform designs by eliminating the need for visualizing the site via the scope or platform.

The various embodiments described throughout this specification provide an energy consuming visualization system. The energy consuming visualization system generally comprises an imaging device, an illumination source, wireless energy transmission circuit elements, signal transceivers, image display electronics, a display, tissue engaging elements (either internal/external magnet arrangement, sutures, adhesives, clamps, corkscrews, or “fangs” to attach to a wall in an internal body cavity), and manipulation devices.

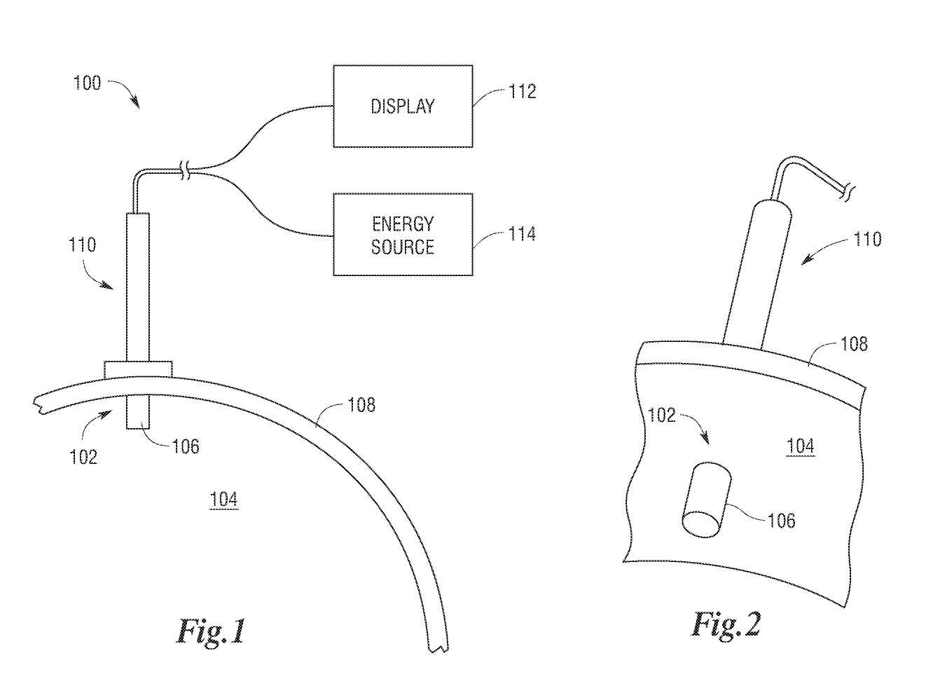

FIGS. 1 and 2 illustrate one embodiment of a system 100. In one embodiment the system 100 comprises an energy consuming module 102 that is deployable and positionable within a body cavity 104. As shown in the illustrated embodiment, the energy consuming module 102 is located within the peritoneal cavity 104 and magnetically held in place through the abdominal wall 108 by a combined external magnet, energy transmitter, signal receiver, and handle device 110. The energy consuming module 102 is suitable for use within the body cavity 104. In one embodiment, the energy consuming module 102 comprises an antenna to transmit and receive signals and a wireless energy module to supply energy to the energy consuming module 102. In one embodiment, the energy consuming module 102 comprises a positioning element used to position and locate the energy consuming module 102 within the body cavity 104. For example, in embodiments of the energy consuming module 102 comprising a visualization module, the positioning element enables the visualization module to be oriented at the desired angle and distance to obtain a suitable view of the site. A housing 106 supports the antenna, the wireless energy module, and the positioning element of the energy consuming module 102, as subsequently described in more detail.

A manipulation module 110 (e.g., handle) is located outside the patient's body cavity 104 to manipulate the energy consuming module 102. In one embodiment, the manipulation module 110 comprises a positioning element, which is used to manipulate the positioning element located within the energy consuming module 102. In various embodiments, the manipulation module 110 also includes transceivers to communicate with the energy consuming module 102 via the antenna and a wireless energy transfer circuit elements to wirelessly supply energy to the energy consuming module 102. As shown in FIGS. 1 and 2, for example, energy is transferred wirelessly to the energy consuming module 102 across the abdominal wall 108 without wires traversing the abdominal wall 108. In one embodiment, the manipulation module 110 may be wired or wirelessly coupled to other devices located external to the patient such as the display device 112 and/or the energy source 114.

In one embodiment, the energy consuming module 102 may comprise a visualization system that is deployable within the body cavity 104 through the abdominal wall 108, for example. The visualization system comprises electronic components configured for recording and transmitting images using wireless data transmission techniques. The electronic component and associated imaging and transmitting electronics are powered by the wireless energy module by way of wireless energy transfer techniques. In the embodiment illustrated in FIGS. 1 and 2, the energy consuming module 102 is implemented as a visualization system and comprises a camera that is wirelessly coupled to the display device 112 and the energy source 114.

It will be appreciated that in various embodiments, the energy consuming module 102 may be implemented in a variety of systems. In the context of a visualization system embodiment, the energy consuming module 102 comprises an imaging device having a camera. In other embodiments, the energy consuming module 102 may comprise a light source (e.g., LED), circuit elements in a camera module to transmit video signals wirelessly through the abdominal wall 108, circuit elements in a camera module to adjust focus or zoom by driving a motor that moves one or more than one lens, a motor to pan and tilt a camera, circuit elements to charge a battery or capacitor, a motor to close a grasper, a motor to drive an endocutter to close, form staples, and cut tissue, a motor to raise or lower a tissue retractor, a monopolar or bipolar electro-cautery device, a solenoid or motor to lock and cut a suture device, an electromagnet to enhance magnetic attraction to an external magnet, a laser to weld and/or solder tissue, or any combinations thereof, among other embodiments of energy consuming modules.

As shown in FIGS. 1 and 2, the energy consuming module 102 may be introduced inside a patient using minimally invasive surgical techniques or conventional open surgical techniques to perform a number of surgical, therapeutic, or diagnostic activities. In other techniques, the energy consuming module 102 may be located proximate to a patient rather than within a patient, without limitation. Minimally invasive techniques provide more accurate and effective access of a site for diagnostic and treatment procedures. In some instances it may be advantageous to introduce the energy consuming module 102 into the patient using a combination of minimally invasive and open surgical techniques. The embodiments of the energy consuming module 102 disclosed herein may be employed in endoscopic, laparoscopic, thoracoscopic, keyhole or open surgical procedures, conventional laparotomies, or any combinations thereof. In one embodiment, the energy consuming module 102 disclosed herein may be introduced to the site through a natural opening of the body such as the mouth, anus, and/or vagina or may be introduced to the site percutaneously. Other portions of the energy consuming module 102 may be introduced into the site or treatment region endoscopically (e.g., laparoscopically and/or thoracoscopically), through small keyhole incisions pre-existing for a trocar, or via a trocar, or through a natural orifice.

Various embodiments of the energy consuming module 102 described herein may comprise temporarily positionable devices inserted in the body cavity 104 of a patient to provide visualization of a target site or treatment region. The energy consuming module 102 may be introduced into the patient using any of the minimally invasive procedures previously discussed, for example. Visualization embodiments of the energy consuming modules 102 may be wirelessly powered and include wireless transceivers for transmitting signals representative of images captured by a camera and receiving control signals for controlling elements of the energy consuming module 102. Once located at a desired site within the body cavity 104, the energy consuming module 102 may be adapted to provide images of the site including portions of the internal anatomy within the diaphragm or peritoneal cavity such as the lungs, liver, stomach, digestive tract including the small and large intestines and the colon, gall bladder, kidneys, urinary tract, and/or reproductive tract, for example. Images may be obtained during the deployment process as the energy consuming module 102 advances through internal body lumens and cavities. Once the energy consuming module 102 is attached to internal tissue, images of the site may be obtained of to provide a view of the operative field during surgical, therapeutic, or diagnostic procedures. Once positioned proximate to the site, images captured and transmitted by the energy consuming module 102 enable a clinician or surgeon to more accurately diagnose, treat, and observe the treatment region. Embodiments of the energy consuming module 102 may provide images during in-vivo treatment procedures for ablating or destroying live cancerous tissue, tumors, masses, lesions, and other abnormal tissue growths present at the treatment site. Other embodiments of the energy consuming module 102 may be configured to transmit electrical signals to a receiver, which then converts the signals into a viewable image. The signals may be wirelessly transmitted outside the patient, where they are detected by a receiver and coupled to the display 112. In various other embodiments, the energy consuming module 102 may be powered by on-board power sources, such as rechargeable batteries, capacitors, or wireless power transmitters. The embodiments, however, are not limited in the context of positionable energy consuming modules 102 with integrated visualization and illumination devices.

In various embodiments, the energy consuming module 102 described herein may be employed in preoperative patients to screen and diagnose diseases, evaluate tissue without surgery, and to monitor, scan, or otherwise visualize a treatment site inside the patient prior to surgery. The embodiments of the energy consuming module 102 described herein may be employed in surgical or therapeutic procedures to administer sedatives, anesthetics, perform surgical procedures, and to visualize the treatment site or site within the patient during surgery. When positioned at the site, embodiments of the energy consuming module 102 comprising visualization elements illuminate, record images, and transmit the images to an external display 112 located outside the patient. Visualization of the site enables the clinician to accurately diagnose the treatment region and provide a more effective treatment to the patient.

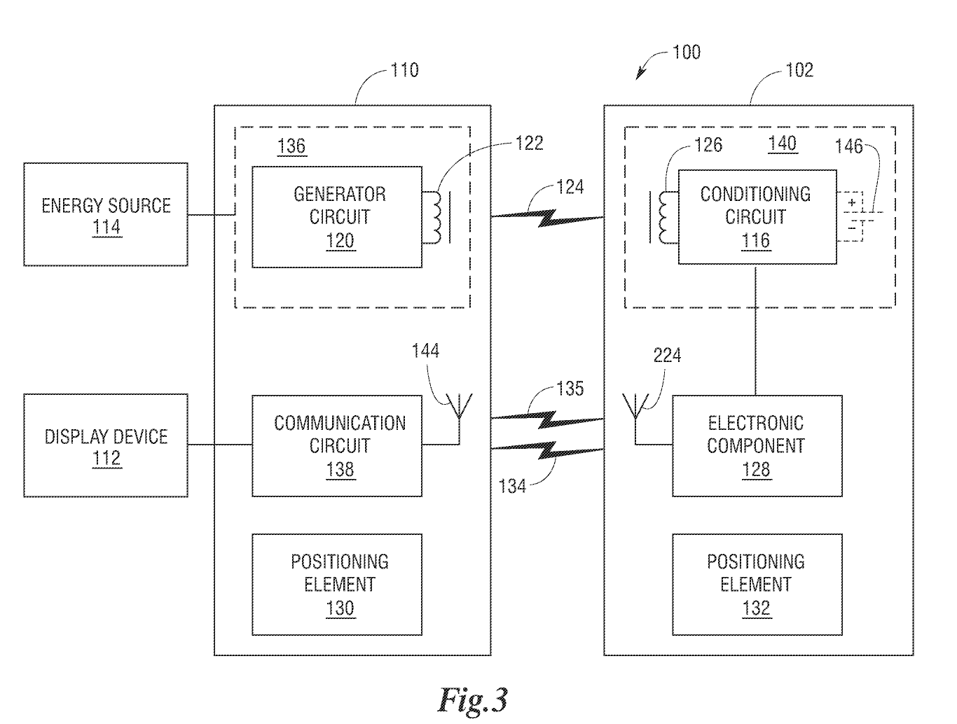

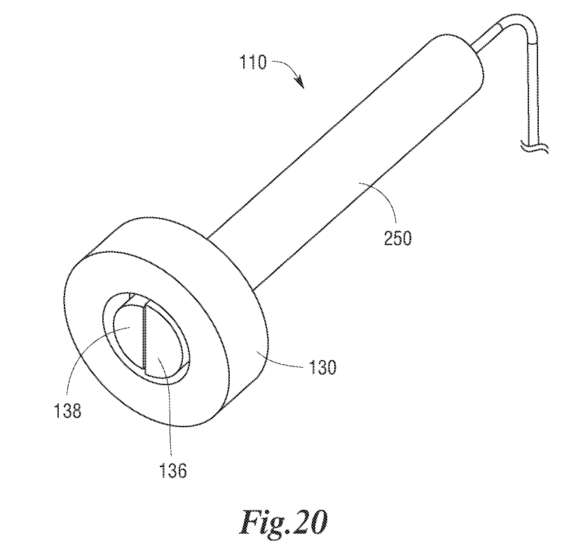

FIG. 3 is a schematic diagram of one embodiment of the system 100 shown in FIG. 1. The manipulation module 110 used outside the body cavity 104 to manipulate a positioning element 132 of the energy consuming module 102 located inside the body cavity 104 (See FIGS. 1 and 2, for example). As shown in FIGS. 3 and 20, one embodiment of the manipulation module 110 comprises a wireless energy transmitter module 136 to couple energy to a wireless energy module 140, which supplies the energy to an electronic component 128. In one embodiment the manipulation module 110 also comprises a communication circuit 138 coupled to an antenna 144 to communicate signals between the energy consuming device 102 and the manipulation module 110. The manipulation module 110 also comprises a positioning element 130 that operatively interacts with the positioning element 132 of the energy consuming module 102 to locate and position the energy consuming module 102, and therefore the electronic component 128, within a desired location of the body cavity 104. In one embodiment, a handle 250 (FIG. 20) is provided that may be grasped by the clinician to manipulate the manipulation module 110 and position the positioning element 132 in the energy consuming module 102 using the positioning element 130 of the manipulation module 110.

The electronic component 128 may comprise one or more than one discrete or integrated electronic element having one or more than one connecting lead or metallic pad. Typical electronic elements include resistors, capacitors, transistors, diodes, amplifiers, logic gates, microprocessors, microcontrollers, memory, inductors, amplifiers, among others, for example.

In various embodiments, the energy consuming module 102 and/or the electronic component 128 are remotely powered using wireless power transmission techniques, such as inductive coupling 124, resonant energy transfer, or other techniques. Wireless energy coupling/transfer, or wireless power transmission, is the process of transmitting electrical energy from an energy source to an electronic load, without interconnecting wires, using electromagnetic fields. Such wireless energy coupling/transfer techniques use alternating current (AC) magnetic fields generated in a first inductive coil (e.g., conductor) located outside the patient to stimulate electrical current through a second inductive coil (e.g., conductor) located inside the patient. An electric transformer is the simplest instance of wireless energy transfer. The primary and secondary circuits of a transformer are not directly connected. In the transformer, the coupling/transfer of energy takes place by electromagnetic coupling through a process known as mutual induction. The embodiments, however, are not limited in this context. Other wireless energy transfer technology also may be employed without limitation. For example, radio frequency (RF) energy transfer devices produced by Powercast, Inc., can be used to transfer energy across a distance. The Powercast system is capable of achieving a maximum output of about 6 volts for a little over one meter. Other low-power wireless power technology has been proposed and is described in U.S. Pat. No. 6,967,462, for example.

In one embodiment, the wireless energy transmitter module 136 of the manipulation module 110 is coupled to the energy source 114, which provides power (voltage and current) to the wireless energy transmitter module 136. A generator circuit 120 converts the power received from the energy source 114 and supplies alternating current (AC) power to a generating element 122. In various embodiments, the generating element 122 may comprise one or more than one single or multi-turn inductive coil, for example. In one embodiment, the energy consuming module 102 comprises a wireless energy module 140, which comprises a collection element 126 to couple energy generated by the generating element 122. In one embodiment, the collection element 126 may comprise one or more than one single or multi-turn inductive coil, for example. The transfer of energy from the generating element 122 to the collection element 126 may be via inductive coupling 124 as shown, or via resonant energy transfer, for example, in both instances without employing interconnecting wires. Thus, energy is transmitted wirelessly via inductive coupling 124 from the manipulation unit 110 to the energy consuming module 102. As shown in FIGS. 1 and 2, for example, the energy is wirelessly transmitted from the manipulation module 110 to the energy consuming module 102 across the abdominal wall 108.

Inductive coupling 124 uses magnetic fields that are generated by the movement of electric current through a wire forming the generating element 122. The magnetic field induces a current in the collection element 126. As is well known in the art, when electrical current moves through the wire, it creates a circular magnetic field around the wire. Bending the wire into a first coil amplifies the magnetic field. The more loops the coil makes, the bigger the field will be. If a second coil of wire is placed in the magnetic field, the field can induce a current in the wire of the second coil. This is essentially how a transformer works and how the wireless energy module 140 supplies energy to the electronic component 128 and/or charges a rechargeable element 146 such as a rechargeable battery by inductive coupling 124. Alternatively, the rechargeable element 146 may be implemented as a capacitor circuit that may be charged to store energy and power circuits connected thereto. Current from the energy source 114 flows through the generator circuit 120 and the generating element 122 (e.g., first coil) portion of the wireless energy transmitter module 136, creating a magnetic field. In a transformer, the first coil is called the primary winding. When the wireless energy transmitter module 136 is energized and placed near the wireless energy module 140, the magnetic field generated by the first coil induces a current in the energy collection element 126 (e.g., second coil), or secondary winding, which connects to a conditioning circuit 116 and/or the rechargeable element 146. The conditioning circuit 116 converts this current into a suitable voltage and current for operating the electronic component 128 by or for charging the rechargeable element 146.

Resonant energy transfer techniques can produce larger and stronger fields that can induce current from farther away than can be achieved by inductive coupling alone. This non-radiative energy transfer involves stationary fields around transmitting and receiving coils rather than fields that spread in all directions. Power can be transferred efficiently between coils separated by a few meters by adding resonance to the system. Induction can take place if the electromagnetic fields around the coils resonate at the same frequency. In one embodiment, a curved coil of wire is used as an inductor and a capacitance plate, which can hold a charge, is attached to each end of the coil. As electricity travels through the coil, the coil begins to resonate at a resonant frequency, which is the product of the inductance of the coil and the capacitance of the plates. The coil and capacitive plates may be curved. Electricity, traveling along an electromagnetic wave, can tunnel from a transmitting coil to a collecting or receiving coil located within a few meters of each other. As long as both coils have the same resonant frequency, streams of energy move from the transmitting coil to the receiving coil. In another embodiment, one coil can send electricity to several receiving coils, as long as they all resonate at the same frequency. One coil can recharge any device that is in range, as long as the coils have the same resonant frequency.

The collection element 126 of the wireless energy module 140 is coupled to the conditioning circuit 116 that generates a suitable operating voltage and current for use by the electronic component 128. In one embodiment, the conditioning circuit 116 may be coupled to the optional rechargeable element 146 (e.g., the rechargeable battery or capacitive circuit shown in phantom) that can be charged using the energy coupled/transferred to the collection element 126 via inductive coupling 124. The rechargeable element 146 is charged by inductively coupling 124 energy from the generating element 122 (e.g., generating coil) to the collection element 126 (e.g., collection coil). The conditioning circuit 116 provides a voltage and current that is suitable for charging the rechargeable element 146.

In one embodiment, the communication circuit 138 comprises a receiver to receive imaging signals 134 generated by an imaging device portion of the electronic component 128. The electronic component 128 comprises a transmitter coupled to an antenna 224 for transmitting imaging signals 134 to the receiver portion of the communication circuit 138. In one embodiment, the communication circuit 138 comprises a transmitter to transmit control signals 135 to the electronic component 128. In one embodiment, the control signal 135 may be employed to adjust the focus of a lens system. In various embodiments, the control signals 135 may be used to control the operation of the energy consuming module 102, the electronic component 128, or any other component of the energy consuming module 102.

The positioning element 130 of the manipulation module 110 interacts with the positioning element 132 of the energy consuming module 102. The interaction between the positioning elements 130, 132 is exploited to locate and position the energy consuming module 102 and/or to fix the energy consuming module 102 in place once it is located in a desired position within the body cavity. In one embodiment, the positioning elements 130, 132 are permanent magnets. In other embodiments, the positioning elements 130, 132 may be electromagnets and/or combinations of permanent magnets and electromagnets. In other embodiments, the positioning element 132 of the energy consuming module 102 also may comprise hooks or other tissue engaging elements to hold the energy consuming module 102 in place within the body cavity 104 (FIGS. 1 and 2), as previously described.

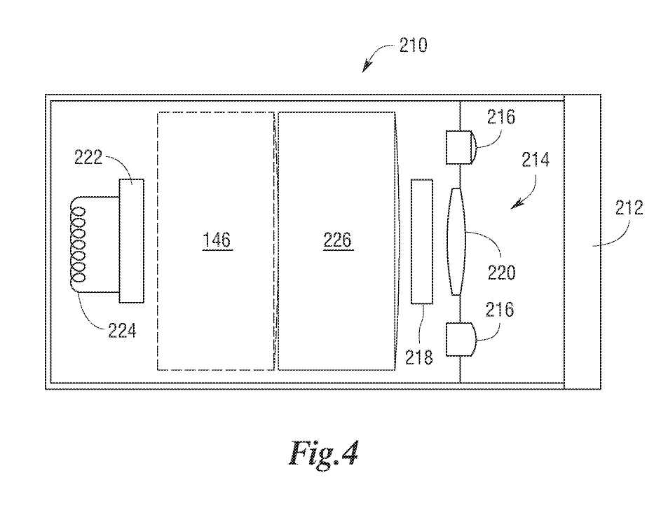

FIG. 4 is a schematic diagram of an imaging device 210. In one embodiment, the electronic component 128 comprises the imaging device 210 or an equivalent imaging device. The imaging device 210 may be employed for viewing inside the body cavity 104 (FIGS. 1 and 2) and for transmitting at least video data from inside the body cavity 104. FIG. 4 illustrates the imaging device 210 and its components. In one embodiment the imaging device 210 comprises an optical window 212 and an imaging system 214 for obtaining images from inside the body cavity 104, such as the peritoneal cavity, for example. The imaging system 214 comprises an illumination source 216, such as a white LED, an imaging camera 218 (e.g., CCD, CMOS) comprising an image sensor array, which detects the images, and an optical system 220, which focuses the images onto the imaging camera 218. The illumination source 216 illuminates the inner portions of the body cavity 104 through the optical window 212. The imaging device 210 further includes a transmitter 222 and an antenna 224 for transmitting the video signal of the imaging camera 218, and an energy source 226 that supplies power to the electronic elements of the imaging device 210.

As previously discussed, the energy source 226 may comprise the wireless energy module 140 and optionally the rechargeable element 146. The energy source 226 may be an on-board energy source located within a housing or body of the imaging device 210, such as the rechargeable element 146 or may be a remote energy source located outside the housing or body of the imaging device 210. In other embodiments, the imaging device 210 may be powered by remote energy sources using wireless energy transfer techniques such as induction or resonant transfer, as previously discussed with reference to FIG. 3.

It will be appreciated that a plurality of CCD or CMOS imaging cameras 218 may be used in the imaging device 210 and system. Each CCD or CMOS based imaging camera 218 may include its own optical system 220 and either one or more illumination sources 216 in accordance with specific requirements of the device or system.

Images obtained by the imaging camera 218 are transmitted to a receiving system, e.g., imaging signals 134 transmitted to the communication circuit 138 in the manipulation module 110 as shown in and described with reference to FIG. 3, which also may include a data processing unit such as a microprocessor or microcontroller, for example. The receiving system and data processing unit are typically located outside the patient. The images may be processed using any suitable digital or analog signal processing circuits and/or techniques. Furthermore, the images may be stored in electronic storage media such as, for example, memory devices, magnetic disks, optical disks. The images may be transmitted wirelessly to external devices such as the display device 112 (FIG. 3) for storing, displaying, or further processing the images in real-time.

The imaging device 210 may be formed in any shape suitable for insertion into an internal body cavity. Furthermore, the imaging device 210 may be attached or affixed on to an instrument that can be inserted into various body lumens and cavities, such as on an endoscope, laparoscope, thoracoscope, stent, needle, and catheter. Thus, the imaging device 210 may be introduced into the internal body cavity 104 (FIGS. 1 and 2) using an endoscopic device or by open surgical techniques.

A suitable imaging camera 218 is, for example, a “camera on a chip” type CMOS imager with integrated active pixel and post processing circuitry. The single chip camera can provide either black and white or color signals. The imaging camera 218 may be designed such that it is less sensitive to light in the red spectrum than known CMOS cameras. The imaging camera 218 may comprise one or more CCD arrays or CMOS devices such as active-pixel sensors. As used herein, the term “camera” is intended to cover any imaging device comprising image sensors suitable for capturing light and converting images to electronic signals that can be stored in electronic storage media or transmitted, by wire or wireless techniques, to external devices for displaying the images on video monitors. The images may include still photographs or a sequence of images forming a moving picture (e.g., movies or videos). Optical systems comprising one or more lenses may be optically coupled to the one or more image sensors, similar to those employed in digital cameras and other electronic imaging devices, to convert an optical image to an electric signal. The image sensor portion of the imaging camera 218 may comprise one or more arrays of CCD or CMOS devices such as active-pixel sensors. The imaging camera 218 captures light and converts it into electric signals. A large area image sensor may be used to provide a substantially high quality image equivalent to that obtainable with standard laparoscopes, for example. In one embodiment, the imaging camera 218 may comprise a sensor array having approximately a 10 mm diameter image input area. In other embodiments, motors may be employed for orienting, panning, zooming, and/or focusing the imaging camera 218 and providing an optimal viewing angle of the target anatomy in a desired orientation. As previously discussed, these functions may be remotely controlled by the control signals 135 transmitted by the manipulation module 110.

The optical system 220 comprises at least one lens and optionally mirrors and/or prisms for collecting and collimating remitted light on to the pixels of the imaging camera 218. Typically, the optical system comprises an aspherical focusing lens. A suitable lens may be designed in accordance with specific object plane, distortion, and resolution parameters.

The illumination source 216 transmits light to the walls of the internal body cavity 104 (FIGS. 1 and 2) via the optical window 212. The lens of the optical system 220 then focuses remittent light onto the pixels of the imaging camera 218.

A single or plurality of illumination sources 216 or a specific integrated illumination source may be used and positioned in accordance with specific imaging requirements, such as to avoid stray light. Also, the optical window 212 may be positioned and shaped according to the device shape and according to specific imaging requirements. For example, imaging conditions can be obtained when the optical window 212 is formed to define an ellipsoid shaped dome and the imaging camera 218 and illumination sources 216 are positioned in proximity of the focal plane of the shape defined by the optical dome.

The in-vivo sites imaged are usually very close to the imager. It is therefore possible to satisfy the illumination requirements of the imaging process utilizing solid state illumination sources, such as one or more than one LED. Accordingly, in one embodiment, the illumination source 216 comprises one or more than one white LED and preferably one or more than one white LED. The white light emitted from a white LED has a small fraction of red light and even smaller fraction of infrared (IR) light. Hence, a white LED is beneficial for use with silicon based image sensors (such as CMOS imaging cameras) because of the sensitivity of silicon to red and IR light. In a system which includes the imaging camera 218 with its reduced sensitivity to light in the red spectrum and a white LED illumination source 216, no IR reject filters (photopic filters) are needed. One or more than one illumination source 216 may be located on either ends of the body to illuminate the site to be imaged. The illumination source 216 may comprise one or more than one light source. In one embodiment, the illumination source 216 may comprise a single LED or a combination of LEDs selected to produce light of a desired spectrum. In one embodiment, the illumination source 216 may be coupled to motors for orienting, panning, zooming, and/or focusing the illumination source 216 to provide optimal illumination of the site. As previously discussed, these functions may be controlled by the control signals 135.

A suitable transmitter 222 may comprise a modulator which receives the video signal (either digital or analog) from the imaging camera 218, a RF amplifier, an impedance matcher, and an antenna 224. In wireless applications, the imaging device 210 may comprise a transceiver (e.g., transmitter/receiver) to transmit the video signal (e.g., imaging signals 134 in FIG. 3) from the imaging camera 218 and to receive command signals (e.g., control signals 135 in FIG. 3) for operating aspects of the imaging device 210 remotely.

A suitable antenna 224 may comprise any suitable RF antennas. Examples of suitable antennas includes, without limitation, embedded antennas designed for video telemetry, rectangular microstrip antennas (e.g., patch or planar antennas) comprising a conductor (square or otherwise) formed over a ground plane, slot antennas, tapered slot antennas, wire antennas, stub antennas, or blade antennas, among numerous other suitable antenna devices and/or configurations. The antenna 224 may comprise a single radiating element or an array of radiating elements.

In various embodiments, the imaging device 210 may be coupled to a circuit comprising any necessary electronic components or elements for processing, storing, and/or transmitting the images received by the image sensor. The images may be processed by any suitable digital or analog signal processing circuits and/or techniques implemented in logic, software, or firmware. Furthermore, the images may be stored in electronic storage media such as, for example, memory devices. The circuits may be coupled by one or more connectors. It will be appreciated by those skilled in the art that a single circuit or multiple circuits may be employed to process, store, and transmit the images without limiting the scope of the illustrated embodiments.

The circuits, image sensors, batteries, illumination sources, transmitters, transceivers, antennas, and/or any other electronic component, may be disposed on a variety of substrates such as a printed circuit board and/or ceramic substrate and may be connected by one or more connectors.

One or more substrates (e.g., printed circuit boards, ceramic) may be used to mechanically support and electrically connect any of the electronic components associated with the imaging device 210 using conductive pathways, or traces. The substrate may be a rigid or flexible printed circuit board, ceramic, or may be formed of other suitable materials, and may be interconnected by one or more connectors.

In various other embodiments, the imaging device 210 may be implemented in a manner similar to that described in U.S. Pat. Nos. 5,604,531 and 7,009,634, each of which is incorporated herein by reference in its entirety.

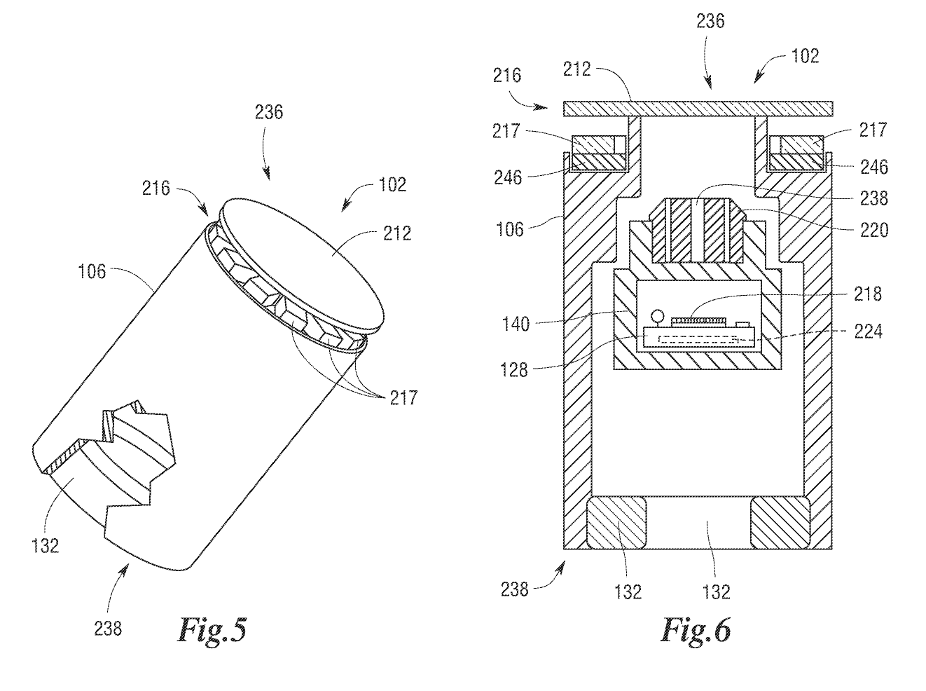

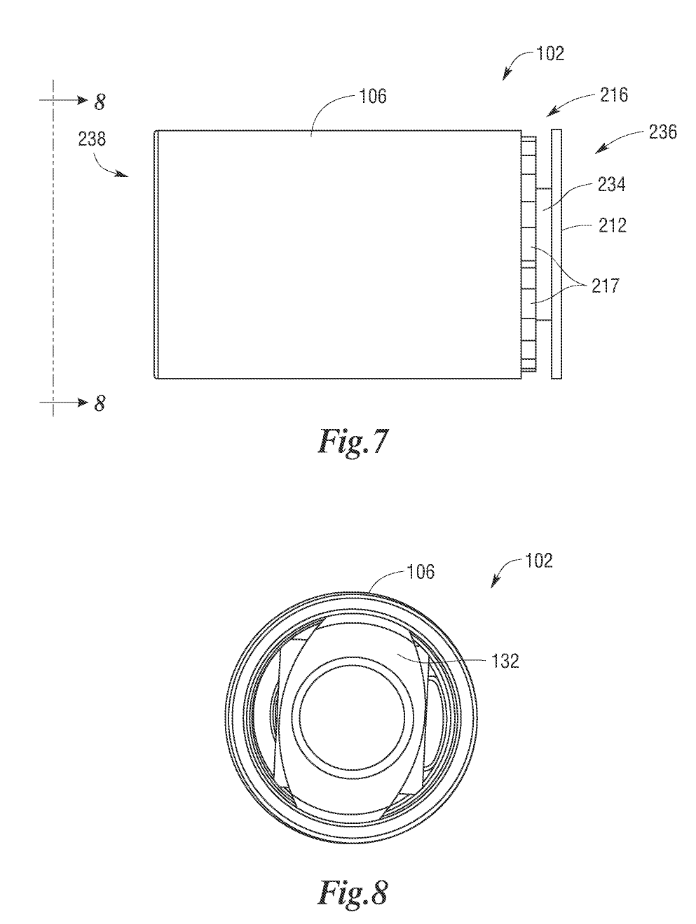

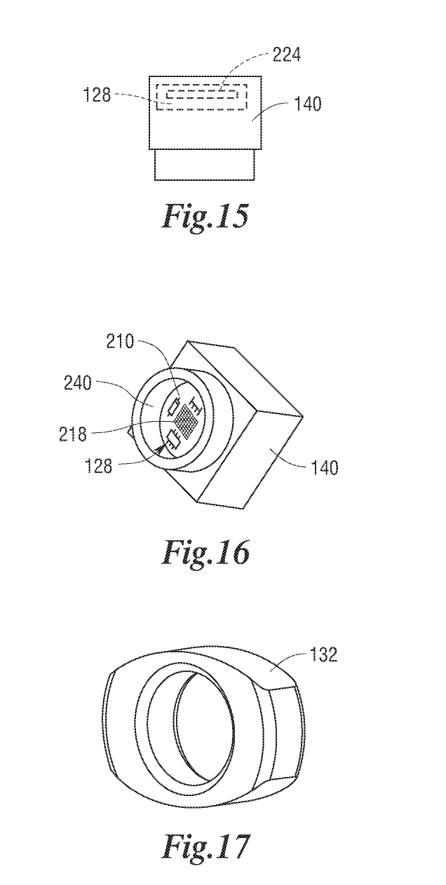

FIGS. 5-9 illustrate one embodiment of an energy consuming module 102. In the illustrated embodiment, the energy consuming module 102 comprises a housing 106 to support a positioning element 132 in the form of a permanent magnet (also shown in FIG. 17), a wireless energy module 140, an optical system 220, and an illumination source 216. As further illustrated in FIGS. 4, 15, and 16, the wireless energy module 140 also serves as the camera body to contain various elements of the electronic component 128 including the imaging device 210, the imaging camera 218, the transmitter 222, and the antenna 224. In one embodiment, the wireless energy module 140 supplies power to the imaging device 210, e.g., the imaging camera 218, the transmitter 222, and the antenna, and in one embodiment also may supply power to the illumination source 216.

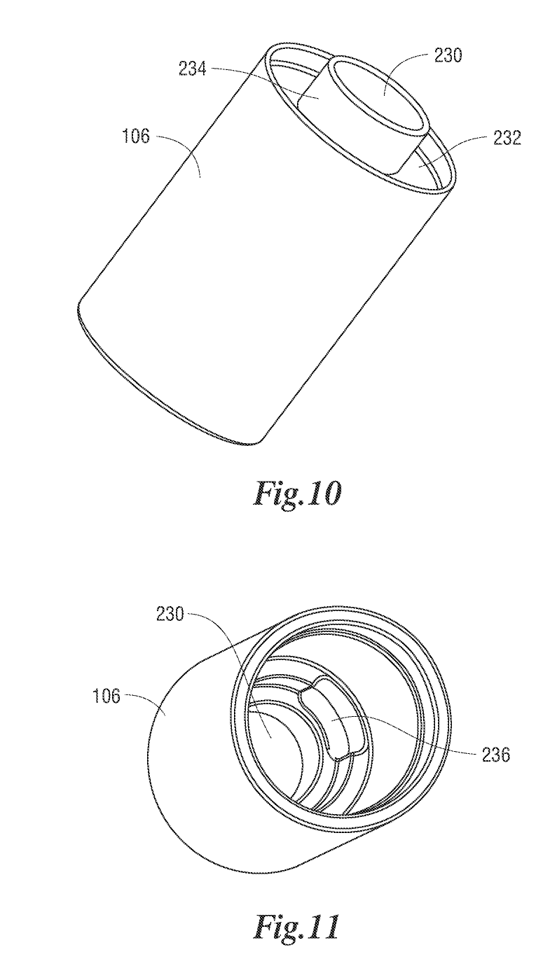

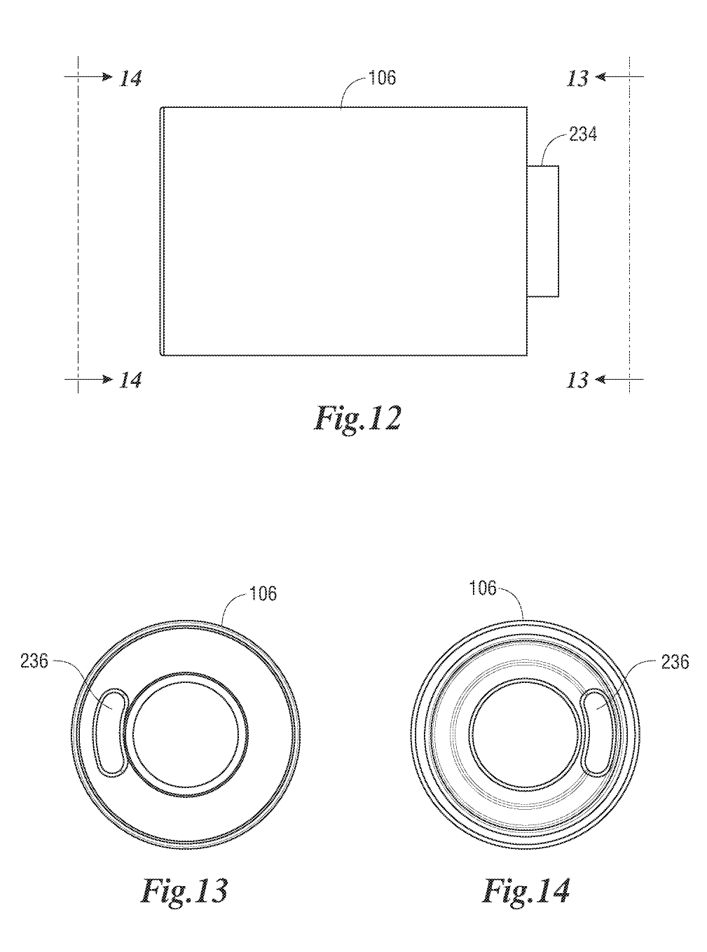

As shown in FIGS. 5-14, in one embodiment the housing 106 comprises a first distal aperture 230, or camera aperture, defined by a neck portion 234 located at a distal end 236 of the housing 106. Although the neck portion 234 is shown to be cylindrical in shape, it may be formed of any suitable shape. Light remitted from the object being imaged is received within the aperture 230. The optical system 220 is located within an aperture 240 of the wireless energy module 140/electronic component 128 below the first distal aperture 230. A second distal aperture 232 formed about the neck portion 234 is defined within the housing 106 to receive the illumination source 216 and the plurality of LEDs 217. Additional features of the housing 106 are shown in FIGS. 10-14.

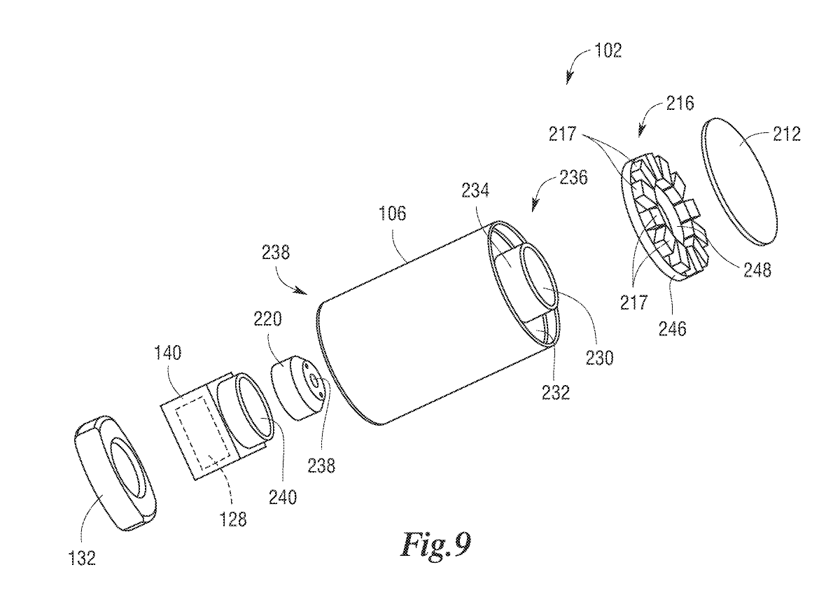

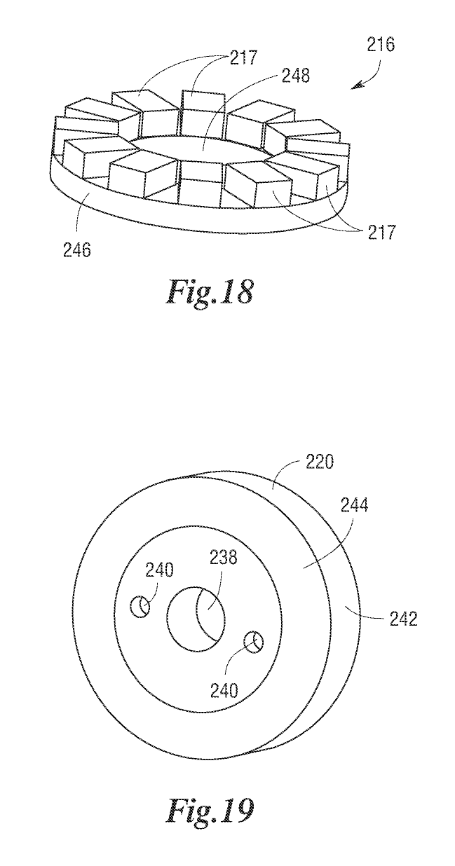

FIGS. 5-7, 9, and 18 illustrate one embodiment of the illumination source 216. The illumination source 216 illuminates the inner portions of the body cavity 104 (FIGS. 1 and 2) through the optical window 212 or lens. The illumination source 216 comprises one or more than one LED 217 mounted on a circuit board 246. In one embodiment, in addition to supplying energy to the electronic component 128, the wireless energy module 140 also supplies power to the illumination source 216. It will be appreciated, however, that the illumination source 216 and the LEDs 217 may be separately powered by an inductive coil similar to collection element 126 of the wireless energy module 140 for coupling energy generated by the generating element 122, as shown in FIG. 3, for example. As previously discussed, the antenna 224 is used for transmitting the video signal generated by the imaging camera 218. As shown in FIGS. 9 and 18, an aperture 248 provides a light path to the optical system 220 and the imaging camera 218 for the object being imaged.

As illustrated in FIGS. 6, 9, and 19, the first distal aperture 230, the aperture 238 of the optical system 220, and the aperture 240 of the wireless energy module 140/electronic component 128 are optically aligned and provide a light path to the imaging camera 218. The optical system 220 focuses the images onto the imaging camera 218 located within the body of the wireless energy module 140. In one embodiment, the optical system 220 comprises a substantially cylindrical body 242 and a tapered portion 244. The aperture 238 of the optical system 220 provides a light path between the distal aperture 230 and the aperture 240 of the wireless energy module 140/electronic component 128 for the imaging camera 218.

Additional embodiments are disclosed herein that provide “in flight” recharging of energy consuming modules located within the patient, particularly wireless cameras and light source systems. As previously discussed, in minimally invasive surgery, it is desirable to deliver devices into the patient's body via an access port in a way that allows the port to be available for other uses once the device is delivered. One class of such devices is magnetically-based and typically includes an internal end-effector that provides therapy to the patient (e.g., electro-cautery) or information to the surgeon (e.g., video camera) and an external magnet used by the surgeon to control the internal device.

Some of the devices delivered through the port may be electronic in nature and require power or electronic data to be delivered to them to operate, for example, to adjust the focus of a lens system. They also may need to deliver electronic information to personnel in the operating room in the form of an imaging stream, for example. Other devices may employ an electronic connector, such as a motorized stapler, electro-cautery device, harmonic scalpel, bi-polar forceps, among others. Even other devices may require a mechanical input, for example, a drive system to lower a camera or an electro-cautery pencil on an arm.

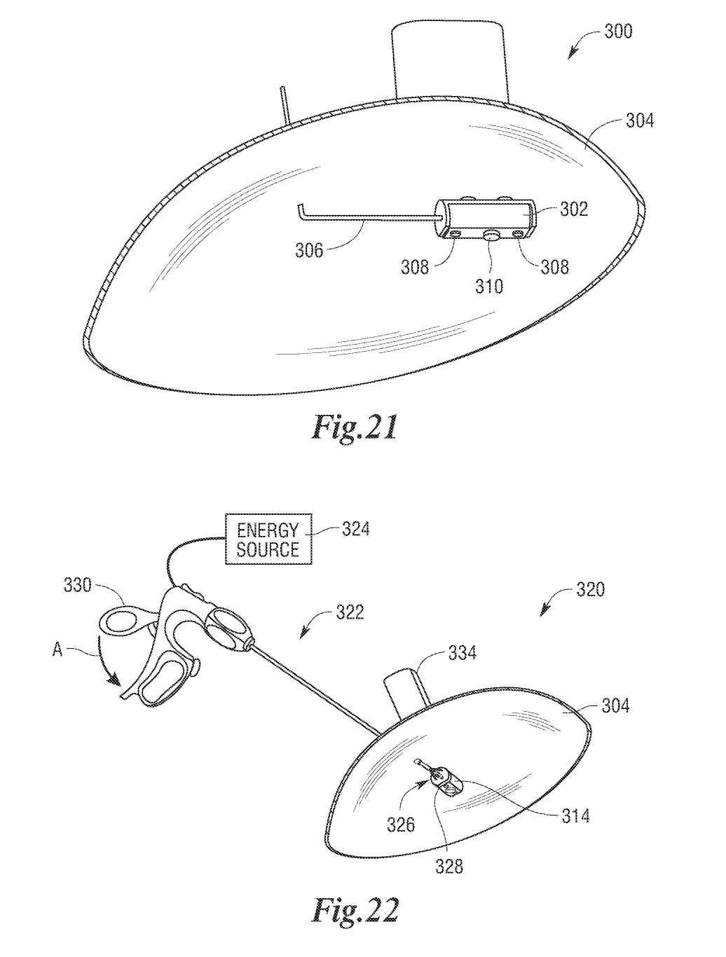

FIG. 21 illustrates a system 300 for coupling the previously mentioned energy consuming modules such as imaging device 302 in and out of the abdominal wall 304 of a patient via a hardwired tether 306. Nevertheless, it would be preferable to minimize or eliminate the tether 306. Wireless transmission of the video signal as previously discussed is well understood and has been widely demonstrated. Most applications, however, still employ batteries or capacitors to power illumination sources 308 (e.g., LEDs) and a camera 310. The time required to complete many medical procedures, however, is longer than can be supported by reasonable sized batteries. Thus, it would be desirable to be able to charge a rechargeable element of an energy consuming module during a procedure (e.g., “in-flight” or “in-situ”) with little or no down-time.

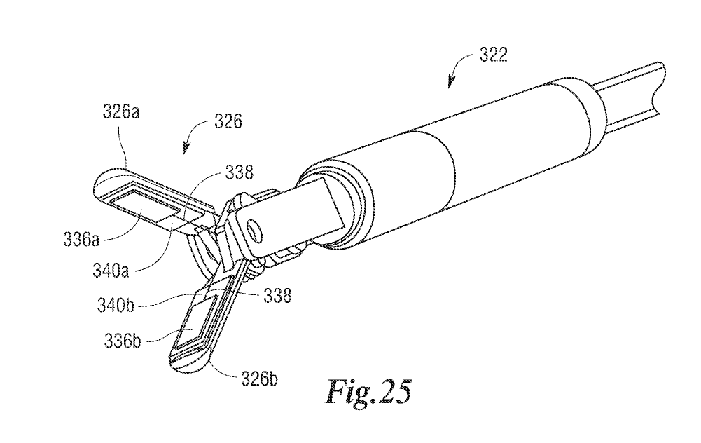

Accordingly, various embodiments illustrated with reference to FIGS. 22-25 herein provide a system 320 of devices and methods for charging a battery or capacitor located within an energy consuming module such as visualization module 314 (e.g., imaging module or camera) periodically during a procedure, thus allowing the visualization module 314, or any other energy consuming module, to be recharged during the procedure with little or no down-time. In operation and structure, the visualization module 314 is substantially similar to the imaging device 210 described above with reference to FIG. 3, where the energy source is the rechargeable element 146 (FIGS. 3 and 4). As subsequently described in further detail, in one embodiment, a rigid locking grasper 322 operable by a handle 330 where a jaws 326 portion at the distal end closes to grasp an object when the handle 330 is squeezed in the direction indicated by arrow A. The grasper 322 is electrically connected to a power supply. The power supply may be an energy source 324 located outside the abdominal wall 304 of the patient or a battery located within the handle 330 portion of the grasper 322. Once connected to a power supply, the grasper 322 can be used to charge a rechargeable element of the visualization module 314 located inside the patient inside the abdominal wall 304. The rechargeable element may be substantially similar to the rechargeable element 146 previously discussed. In one embodiment, the grasper 322 can function as a standard locking grasper, but jaws 326 of the grasper 322 can be configured such that they are electrically isolated from each other and can provide a direct current (DC) voltage to the energy consuming visualization module 314. The jaws 326 may be configured to grasp a feature such as an electric terminal 328 provided on the energy consuming visualization module 314 and electrically coupled to the rechargeable element 146 and quickly charge the rechargeable element 146 to allow non-stop operation of the energy consuming visualization module 314. When not in use as a charger, the grasper 322 may be configured to operate as a conventional grasper. Alternatively, embodiments of the grasper 322 may be configured as a purpose-built device that is insertable in an existing trocar site for charging operation only and not for grasping. Also, other embodiments of the grasper 322 may be configured to be very small in size, for example, less than 2 mm diameter, and may be configured to self-puncture the abdominal wall 304 of the patient for charging and be removed when charging is complete, without using an existing trocar site and without leaving a scar.

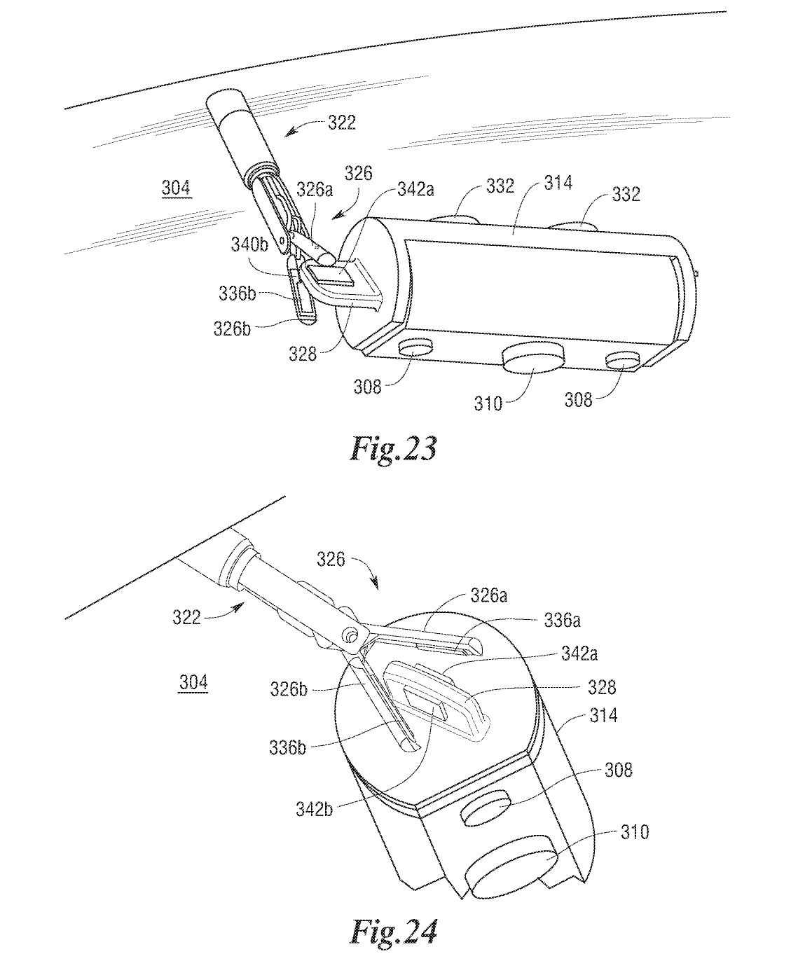

With reference still to FIGS. 23-25, in one embodiment, the jaws 326 of the grasper 322 comprise a first jaw member 326a and a second jaw member 326b. The first and second jaw members 326a, b of the grasper 322 comprise respective first and second electrically conductive pads 336a and 336b (e.g., electric terminals) that are coupled to the energy source 324 via corresponding first and second conductors 340a and 340b. The area 338 surrounding the electrically conductive pads 336a, b of the jaw members 326a, b is formed of an electrically insulative material. As shown in FIGS. 23 and 24, the at least one electric terminal 328 comprises first and second electric contacts 342a and 342b, which are coupled to corresponding terminals of a rechargeable element (e.g., the rechargeable element 146 shown in FIGS. 3 and 4) located in the visualization module 314. The first and second electric contacts 342a, b of the electric terminal 328 are configured to receive the corresponding electric conductors 336a, b on the grasper jaws 326 to supply energy to the rechargeable element 146 or capacitor from the energy source 324. The electrically conductive portions of the jaws 326 or the terminal 328 may be formed of stainless steel, medical grade stainless steel, copper, brass, aluminum, silver, gold, or any other suitable compatible electrical conductive material. The electrically insulative portions may be formed of plastic, TEFLON®, silicone, or any other suitable compatible electrically insulative material.

As shown in FIGS. 22 and 23, the visualization module 314 comprises positioning elements 332 that work in conjunction with a manipulation module 334. In one embodiment, the positioning elements 332 comprise magnets that cooperate with magnets within the manipulation module 334. In various embodiments, the magnets may be permanent magnets or electromagnets or any combination thereof.

A method of providing images of a treatment site inside the patient in now described with reference to FIGS. 1-20. Initially, the energy consuming module 102 is inserted inside a body cavity 104 using any of the procedures previously discussed. The energy consuming module 102 comprises an electronic component 128 suitable for use within the body cavity 104, an antenna 224 coupled to the electronic component 128 to communicate signals 134, 135, a wireless energy module 140 coupled to the electronic component 128, a positioning element to 132 to locate the electronic component 128 within the body cavity 104, and a housing 108 to support the electronic component 128, the antenna 224, the wireless energy module 140, and the positioning element 132. A manipulation module 110 is located external to the body cavity 104 and is connected to an energy source 114. Energy is wirelessly transmitted from the manipulation module 110 to the energy consuming module 102 across the abdominal wall 108 of the patient.

Once the energy consuming module 102 is inserted into the body cavity 104, the housing 106 of the energy consuming module 102 may be attached to a wall of the body cavity 104. Once attached to the wall of the body cavity 104, the housing 108, and thus the energy consuming module 102 and components thereof, can be positioned with the manipulation module 110.

Once in position and desirably oriented, the imaging device 210 portion of the electronic component 128 is used to capture video images within the body cavity 104. Video signals 134 corresponding to the captured video images are transmitted via the antenna 224 to the manipulation module 110, for example. The video signals 134 are received by a receiver portion of the communication circuit 138 at the manipulation module 110. The video signal 134 is transmitted to a display device 112 where the video is displayed.

With reference now to FIGS. 22-25, a grasper 322 coupled to an energy source 324 is inserted into a body cavity to charge a rechargeable element of an energy consuming module 314.

In summary, numerous benefits have been described which result from employing the concepts described herein. The foregoing description of the one or more than one disclosed embodiment has been presented for purposes of illustration and description. It is not intended to be exhaustive or limiting to the precise form disclosed. Modifications or variations are possible in light of the above teachings. The one or more than one disclosed embodiment was chosen and described in order to illustrate principles and practical applications to thereby enable one of ordinary skill in the art to utilize the various embodiments and with various modifications as are suited to the particular use contemplated. It is intended that the claims submitted herewith define the overall scope.

The energy consuming devices disclosed herein can be designed to be disposed of after a single use, or they can be designed to be used multiple times. In either case, however, the energy consuming devices can be reconditioned for reuse after at least one use. Reconditioning can include any combination of the steps of disassembly of the energy consuming device, followed by cleaning or replacement of particular pieces, and subsequent reassembly. In particular, the energy consuming device can be disassembled, and any number of the particular pieces or parts of the energy consuming device can be selectively replaced or removed in any combination. Upon cleaning and/or replacement of particular parts, the energy consuming device can be reassembled for subsequent use either at a reconditioning facility, or by a surgical team immediately prior to a surgical procedure. Those skilled in the art will appreciate that reconditioning of an energy consuming device can utilize a variety of techniques for disassembly, cleaning/replacement, and reassembly. Use of such techniques, and the resulting reconditioned energy consuming device, are all within the scope of the present application.

Preferably, the various embodiments described herein will be processed before surgery. First, a new or used energy consuming device is obtained and if necessary cleaned. The energy consuming device can then be sterilized. In one sterilization technique, the energy consuming device is placed in a closed and sealed container, such as a plastic or TYVEK® bag. The container and the energy consuming device are then placed in a field of radiation that can penetrate the container, such as x-rays, or high-energy electrons. The radiation kills bacteria on the instrument and in the container. Other sterilization techniques, such as Ethylene Oxide (EtO) gas sterilization also may be employed to sterilize the energy consuming device prior to use. The sterilized energy consuming device can then be stored in the sterile container. The sealed container keeps the energy consuming device sterile until it is opened in the medical facility.

It is preferred that the energy consuming device is sterilized. This can be done by any number of ways known to those skilled in the art including beta or gamma radiation, ethylene oxide, steam.

Although various embodiments have been described herein, many modifications and variations to those embodiments may be implemented. For example, different types of end effectors may be employed. Also, where materials are disclosed for certain components, other materials may be used. The foregoing description and following claims are intended to cover all such modification and variations.

Any patent, publication, or other disclosure material, in whole or in part, that is said to be incorporated by reference herein is incorporated herein only to the extent that the incorporated materials does not conflict with existing definitions, statements, or other disclosure material set forth in this disclosure. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

1. An apparatus, comprising:
an electronic component suitable for use within a body cavity;
an antenna coupled to the electronic component to communicate signals;
a wireless energy module coupled to the electronic component;
a positioning element to locate the electronic component within the body cavity; and
a housing to support the electronic component, the antenna, the wireless energy module, and the positioning element.

2. The apparatus of clam 1, wherein the electronic component comprises an imaging device coupled to the antenna and the wireless energy module.

3. The apparatus of claim 2, wherein the imaging device comprises:
an image sensor array; and
a lens.

4. The apparatus of claim 3, comprising a transmitter coupled to the image sensor array, the transmitter to transmit a signal representative of images captured by the imaging device.

5. The apparatus of claim 1, comprising a light source coupled to the electronic component.

6. The apparatus of claim 5, wherein the light source comprises at least one light emitting diode.

7. The apparatus of claim 1, wherein the wireless energy module comprises an induction coil.

8. The apparatus of claim 1, wherein the positioning element comprises a magnet.

9. The apparatus of claim 1, wherein the housing comprises:
a first distal aperture;
a second distal aperture; and
a first proximal aperture.

10. A system, comprising:
a manipulation module for use external to the body cavity to manipulate a positioning element of an energy consuming module positionable within a body cavity, the manipulation module comprising:
a wireless energy transmitter element to supply energy to a wireless energy module coupled to an electronic component of the energy consuming module;
a communication circuit coupled to an antenna to communicate signals between the electronic component and the manipulation module; and
a positioning element to locate and position the energy consuming module within the body cavity.

11. The system of claim 10, wherein the wireless energy transmitter comprises:
a generator circuit to supply alternating current (AC) power; and
a generating element coupled to the generator circuit to receive the AC power from the generator circuit.

12. The system of claim 11, comprising an energy source coupled to the generator circuit.

13. The system of claim 11, wherein the wireless energy module comprises an energy collection element and wherein the generating element is to transfer energy to the energy collection element of the wireless energy module via inductive coupling.

14. The system of claim 11, wherein the wireless energy module comprises an energy collection element and wherein the generating element is to transfer energy to the energy collection element of the wireless energy module via resonant energy transfer.

15. The system of claim 10, wherein the communication circuit comprises a receiver to receive imaging signals generated by an imaging device portion of the electronic component.

16. The system of claim 15, wherein the communication circuit comprises a transmitter to transmit the imaging signals representative of the images captured by the imaging device to a display device coupled to the manipulation module.

17. The system of claim 16, wherein the transmitter is configured to transmit control signals to the electronic component.

18. The system of claim 10, wherein the positioning element comprises a magnet.

19. An apparatus, comprising:
an electronic component positionable within a body cavity;
an antenna to transmit a signal from the electronic component within the body cavity;
an energy module coupled to the electronic component to supply power to the electronic component;
at least one electric terminal coupled to the energy module to receive an electric conductor to supply energy to the energy module from an energy source located outside the body cavity;
a positioning element to locate the electronic component within the body cavity; and
a housing to support the electronic component, the antenna, the energy module, and the positioning element, the housing configured for deployment within the body cavity.

20. The apparatus of clam 19, comprising an imaging device coupled to the energy module.

21. The apparatus of claim 20, wherein the imaging device comprises an image sensor array.

22. The apparatus of claim 21, comprising a transmitter to transmit a signal representative of images captured by the imaging device.

23. The apparatus of claim 19, comprising a light source coupled to the energy module.

24. The apparatus of claim 23, wherein the light source comprises at least one light emitting diode.

25. The apparatus of claim 19, comprising a rechargeable battery coupled to the energy module.

26. The apparatus of claim 19, comprising a rechargeable capacitor coupled to the energy module.

27. The apparatus of claim 19, wherein the positioning element comprises at least one magnet.

28. The apparatus of claim 19, wherein the at least one electric terminal is configured to receive a grasper comprising at least one electric contact to electrically couple to the at least one terminal to receive energy to recharge the energy module from the energy source.

29. A method, comprising:
locating an energy consuming module within a body cavity, the energy consuming module comprising an electronic component suitable for use within the body cavity, an antenna coupled to the electronic component to communicate signals, a wireless energy module coupled to the electronic component, a positioning element to locate the electronic component within the body cavity, and a housing to support the electronic component, the antenna, the wireless energy module, and the positioning element; and
locating a manipulation module external to the body cavity and wirelessly transmitting power to the energy consuming module.

30. The method of claim 29, comprising:
attaching the energy consuming module to a wall of the body cavity; and
positioning the energy consuming module with the manipulation module.

31. The method of claim 29, comprising:
receiving a video signal from the energy consuming module at a receiver at the manipulation module; and
displaying the video signal on a display device.

32. The method of claim 29, comprising:
inserting a charging grasper coupled to an energy source into the body cavity; and
recharging an energy module of the energy consuming module.
